(19) United States
(12) Patent Application Publication
(10) Pub. No.: US 2015/0206625 A1
(43) Pub. Date: Jul. 23, 2015

(54) Coaxial Cable

(71) Applicant: Yazaki Corporation, Tokyo (JP)

(72) Inventor: Taketo Kumada, Susono-shi (JP)

(73) Assignee: Yazaki Corporation, Tokyo (JP)

(21) Appl. No.: 14/675,957

(22) Filed: Apr. 1, 2015

Related U.S. Application Data
(63) Continuation of application No. PCT/JP2013/076032, filed on Sep. 26, 2013.

(30) Foreign Application Priority Data
Oct. 1, 2012 (JP) 2012-219219

(51) Int. Cl. H01B 7/17

(52) U.S. Cl. CPC H01B 7/17

(57) ABSTRACT

A coaxial cable includes an inner conductor, an insulator formed on an outer peripheral side of the inner conductor, an outer conductor layer formed on an outer peripheral side of the insulator, and a sheath formed on an outer peripheral side of the outer conductor layer. The outer conductor layer has a first shield layer made of metal foil, an insulating layer formed on an outer peripheral side of the first shield layer, and a second shield layer made of metal foil formed on an outer peripheral side of the insulating layer. The first shield layer of the outer conductor layer is glued to the insulator.

### CROSS REFERENCE TO RELATED APPLICATIONS

This application is a continuation of PCT application No. PCT/JP2013/076032, which was filed on Sep. 26, 2013 based on Japanese Patent Application (No. 2012-219219) filed on Oct. 1, 2012, the contents of which are incorporated herein by reference.

### BACKGROUND OF THE INVENTION

1. Field of the Invention

The present invention relates to a coaxial cable.

2. Description of the Related Art

A coaxial cable in which an insulator is formed on the outer peripheral side of an inner conductor and an outer conductor is formed on the periphery of the insulator and also a sheath is formed on the outer peripheral side of the outer conductor is proposed conventionally. In the coaxial cable, a conductor formed by braiding a copper wire in a net shape (hereinafter called braid), a conductor formed by spirally winding a copper wire (hereinafter called a spiral wind), or a conductor with a two-layer structure formed by winding copper or aluminum foil and then forming braid or a spiral wind on the copper or aluminum foil is proposed as the outer conductor (see PTL 1 and PTL 2).
PTL 1: JP-A-2010-186722
PTL 2: JP-A-2009-146704

### SUMMARY OF THE INVENTION

### Technical Problem

However, in the coaxial cable described in PTL 1 and PTL 2, manufacture of the braid or the spiral wind requires time. That is, in the case of manufacturing the coaxial cable, extrusion molding of a core wire including an inner conductor and an insulating layer is performed, and an outer conductor may require manufacturing time 20 to 50 times the extrusion speed of the core wire. Particularly, the coaxial cable with the outer conductor formed in a two-layer structure requires the longer manufacturing time since the outer conductor is formed in the two-layer structure.

The invention has been implemented in view of the circumstances described above, and an object of the invention is to provide a coaxial cable capable of reducing manufacturing time while forming an outer conductor in a two-layer structure.

In order to achieve the object described above, a coaxial cable according to the invention is characterized by the following (1) to (5).

(1) A coaxial cable including an inner conductor, an insulator formed on an outer peripheral side of the inner conductor, an outer conductor layer formed on an outer peripheral side of the insulator, and a sheath formed on an outer peripheral side of the outer conductor layer, wherein the outer conductor layer has a first shield layer made of metal foil, an insulating layer formed on an outer peripheral side of the first shield layer, and a second shield layer made of metal foil formed on an outer peripheral side of the insulating layer, and the first shield layer of the outer conductor layer is glued to the insulator.

According to the coaxial cable of the above (1), the first shield layer and the second shield layer are made of the metal foil, with the result that manufacturing time can be reduced as compared with the case of braiding or spirally winding a metal wire. When the metal foil is used as the outer conductor, impedance characteristics may deviate from a prescribed value, but the first shield layer is glued to the insulator, with the result that the impedance characteristics can be prevented from deviating from the prescribed value. Consequently, the coaxial cable capable of reducing the manufacturing time while forming the outer conductor in a two-layer structure can be provided.

(2) In the coaxial cable of (1), each of the first shield layer and the second shield layer is constructed of copper foil and is 30 μm or less in thickness.

According to the coaxial cable of the above (2), in the case of a bending radius of 3 mm, by setting the thicknesses of the first shield layer and the second shield layer in 30 μm or less with respect to the bending radius, the metal foil can be used in an elastic range and also, the thickness of the whole coaxial cable can be reduced to decrease the diameter of the coaxial cable.

(3) In the coaxial cable of (2), each of the first shield layer and the second shield layer is 8 μm or more in thickness.

According to the coaxial cable of the above (3), the first shield layer and the second shield layer are 8 μm or more in thickness, with the result that a shielding effect in consideration of a skin effect on high-frequency waves can be obtained.

(4) In the coaxial cable of one of (2) and (3), the first shield layer and the second shield layer have the same thickness.

According to the coaxial cable of the above (4), the first shield layer and the second shield layer have the same thickness, with the result that when the thicknesses of these shield layers are set to obtain certain characteristics, one of both the shield layers does not become thick uselessly and the diameter of the coaxial cable can be decreased.

(5) In the coaxial cable of one of (2) to (4), the first shield layer is once wound on the insulator and also, the second shield layer is once wound on the insulating layer.

According to the coaxial cable of the above (5), both of the first shield layer and the second shield layer are once wound, with the result that, for example, as compared with the case of spirally winding the metal foil, a return current does not flow spirally and a resistance value of the outer conductor layer can be prevented from being increased.

The invention can provide the coaxial cable capable of reducing the manufacturing time while forming the outer conductor in the two-layer structure.

### BRIEF DESCRIPTION OF THE DRAWINGS

FIGS. 1A and 1B are configuration views showing a coaxial cable according to the present embodiment, and FIG. 1A is a sectional view, and FIG. 1B is a side view.

FIG. 2 is a graph showing impedance characteristics of a coaxial cable without a glue layer and a conventional coaxial cable.

FIG. 3 is a graph showing attenuation amounts of the coaxial cable without the glue layer and the conventional coaxial cable.

FIG. 4 is a graph showing impedance characteristics of the coaxial cable according to the embodiment and the conventional coaxial cable.

FIG. 5 is a graph showing attenuation amounts of the coaxial cable according to the embodiment and the conventional coaxial cable.

FIG. 6 is an explanatory diagram of strain of an electric wire coating.

FIG. 7 is a graph showing elongation-strength characteristics of copper foil.

FIGS. 8A and 8B are first diagrams describing a shielding effect of a coaxial cable, and FIG. 8A shows a side schematic diagram, and FIG. 8B shows a sectional schematic diagram.

FIGS. 9A to 9C are second diagrams describing a shielding effect of a coaxial cable, and FIG. 9A shows a side schematic diagram, and FIG. 9B shows a sectional schematic diagram, and FIG. 9C shows an equivalent circuit of an outer conductor.

FIG. 10 is a graph showing shielding effects of the coaxial cable according to the embodiment and the conventional coaxial cable.

### DESCRIPTION OF EMBODIMENT

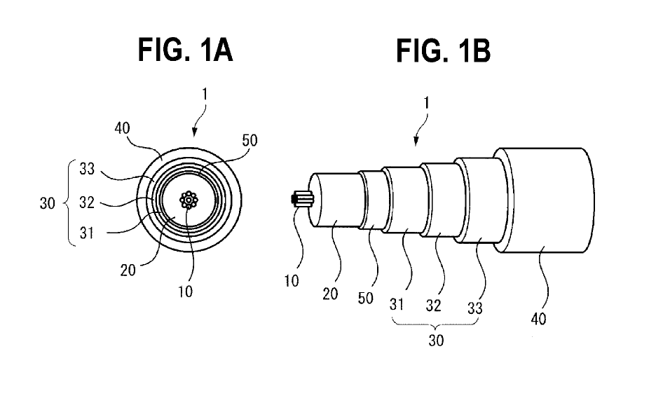

A preferred embodiment of the invention will hereinafter be described based on the drawings. FIGS. 1A and 1B are configuration views showing a coaxial cable according to the present embodiment, and FIG. 1A is a sectional view, and FIG. 1B is a side view. A coaxial cable 1 shown in FIG. 1 includes an inner conductor 10 made of plural conductors, an insulator 20 formed on the outer peripheral side of the inner conductor 10, an outer conductor layer 30 formed on the outer peripheral side of the insulator 20, and a sheath 40 formed on the outer peripheral side of the outer conductor layer 30.

As the inner conductor 10, for example, an annealed copper wire, a silver-plated annealed copper wire, a tin-plated annealed copper wire, or a tin-plated copper alloy wire is used. In the embodiment, the inner conductor 10 has plural conductors, but may have one conductor.

The insulator 20 is a member coating the inner conductor 10 and, for example, PE (polyethylene), PP (polypropylene), or foamed PE or PP is used as the insulator 20. A dielectric constant of this insulator 20 is 3.0 or less. The sheath 40 is a member formed on the outer peripheral side of the outer conductor layer 30, and is constructed of, for example, PE or PP like the insulator 20. As the sheath 40, PET (polyethylene terephthalate) or non-woven fabric may be used.

The outer conductor layer 30 includes a first shield layer 31, an insulating layer 32 formed on the outer peripheral side of the first shield layer 31, and a second shield layer 33 formed on the outer peripheral side of the insulating layer 32.

The first shield layer 31 and the second shield layer 33 are constructed of foil of metal such as copper or aluminum. The insulating layer 32 is constructed of material such as PET. The first shield layer 31, the insulating layer 32 and the second shield layer 33 are preferably constructed of one film. That is, these layers 31, 32, 33 are preferably constructed of the film integrated by sticking metal foil on both surfaces of an insulating film such as PET.

Preferably, the first shield layer 31 is once wound on the insulator 20 (in other words, longitudinally attached) and also, the second shield layer 33 is once wound on the insulating layer 32 (in other words, longitudinally attached). That is, preferably, each of the shield layers 31, 33 is not wound doubly, triply, etc., and is not wound spirally.

Further, in the embodiment, the coaxial cable 1 includes a glue layer 50. The glue layer 50 is an adhesive interposed between the insulator 20 and the first shield layer 31 of the outer conductor layer 30. Since the glue layer 50 is preferably a member welded by preheating of extrusion in an extrusion step of the sheath 40 in manufacture of the coaxial cable 1, a hot-melt material (for example, polyester resin or ethylene-vinyl acetate) is used as the glue layer 50 in the embodiment.

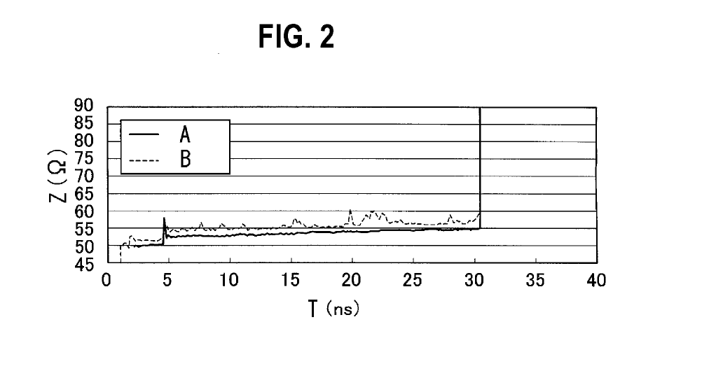

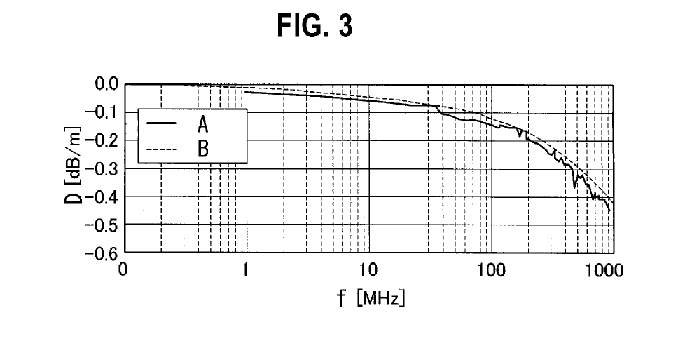

Here, impedance characteristics and attenuation amounts of a coaxial cable without the glue layer 50 and a conventional coaxial cable will be described. FIG. 2 is a graph showing the impedance characteristics of the coaxial cable without the glue layer 50 and the conventional coaxial cable, and FIG. 3 is a graph showing the attenuation amounts of the coaxial cable without the glue layer 50 and the conventional coaxial cable. In FIGS. 2 and 3, numeral A (solid line) shows the conventional coaxial cable, and numeral B (dotted line) shows the coaxial cable without the glue layer 50. In FIG. 2, the axis of ordinate is a characteristic impedance Z (Ω), and the axis of abscissa is time T (ns). In FIG. 3, the axis of ordinate is an attenuation amount D (dB), and the axis of abscissa is a frequency f (MHz).

In the coaxial cable without the glue layer 50, an annealed copper twisted wire with an outside diameter of 0.96±0.03 mm formed by twisting seven annealed copper wires with a diameter of 0.32 mm was used as the inner conductor 10, and cross-linked foamed PE with a thickness of 0.87 mm and an outside diameter of 2.7±0.1 mm was used as the insulator 20. A glued single-sided metal foil tape with an outside diameter of about 2.8 mm was used as the first shield layer 31 of the outer conductor layer 30, and PET with an outside diameter of about 2.9 mm was used as the insulating layer 32, and a single-sided copper foil tape with an outside diameter of about 3.0 mm was used as the second shield layer 33. Heat-resistant PVC (polyvinyl chloride) with a thickness of about 0.34 mm and an outside diameter of 3.8±0.2 mm was used as the sheath 40.

On the other hand, in the conventional coaxial cable, the same materials as those of the coaxial cable without the glue layer 50 were used as an inner conductor and an insulator. A single-sided metal foil tape with an outside diameter of about 2.8 mm was used as an outer conductor layer, and the outer peripheral side of the outer conductor layer was provided with tin-plated annealed copper braid (strand configuration: the number of holdings/the number of counts/mm 0.08/10/16) with an outside diameter of about 3.2 mm. The same material as that of the coaxial cable without the glue layer 50 was used as a sheath.

Since the conventional coaxial cable is arranged so that braid tightens metal foil, the metal foil and the insulator are arranged with no gap, and the impedance characteristics become stable as shown in FIG. 2. In the conventional coaxial cable, the attenuation amount to the frequency also becomes stable as shown in FIG. 3.

On the other hand, in the coaxial cable without the glue layer 50, a gap tends to be created between the first shield layer 31 and the insulator 20, and the impedance characteristics do not become stable as shown in FIG. 2 and also, the attenuation amount to the frequency does not become stable as shown in FIG. 3.

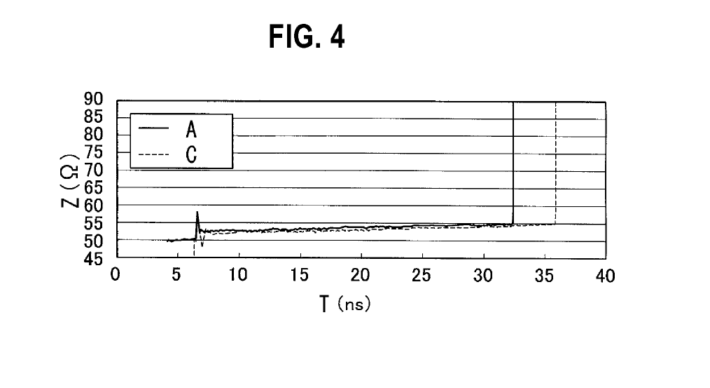

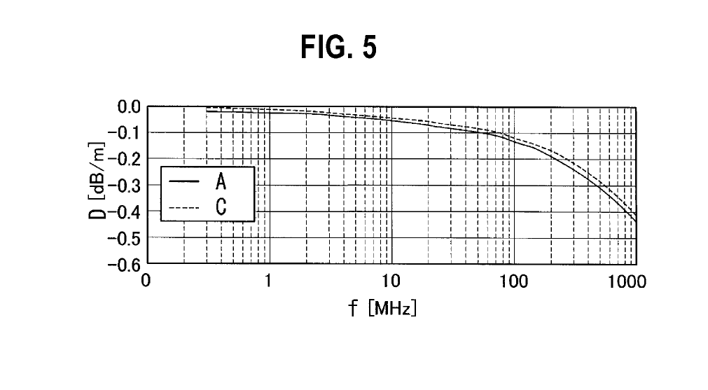

Next, impedance characteristics and attenuation amounts of the coaxial cable 1 according to the embodiment and the conventional coaxial cable will be described. FIG. 4 is a graph showing the impedance characteristics of the coaxial cable 1 according to the embodiment and the conventional coaxial cable, and FIG. 5 is a graph showing the attenuation amounts of the coaxial cable 1 according to the embodiment and the conventional coaxial cable. In FIGS. 4 and 5, numeral A (solid line) shows the conventional coaxial cable, and numeral C (dotted line) shows the coaxial cable 1 according to the embodiment. In FIG. 4, the axis of ordinate is a characteristic impedance Z (Ω), and the axis of abscissa is time T (ns). In FIG. 5, the axis of ordinate is an attenuation amount D (dB), and the axis of abscissa is a frequency f (MHz). In the conventional coaxial cable, braid by a copper wire formed on the outer peripheral side of copper foil and metal foil is used as an outer insulating layer.

In the coaxial cable 1 according to the embodiment, the same materials as those of the coaxial cable without the glue layer 50 were used as the inner conductor 10, the insulator 20, the outer conductor layer 30 and the sheath 40. A hot-melt material made of polyester resin was used as the glue layer 50.

As shown in FIGS. 4 and 5, the impedance characteristics become stable and also, the attenuation amount to the frequency becomes stable in the conventional coaxial cable.

In the coaxial cable 1 according to the embodiment, a gap between the insulator 20 and the first shield layer 31 can be eliminated by interposing the glue layer 50. Accordingly, as shown in FIGS. 4 and 5, the coaxial cable 1 according to the embodiment can achieve the attenuation amount to the frequency and the impedance characteristics equivalent to those of the conventional coaxial cable. Concretely, the characteristic impedance of the embodiment is 51.6Ω and the conventional characteristic impedance is 51.8Ω in about 3 ns.

In addition, the coaxial cable 1 according to the embodiment can reduce manufacturing time since the braid is not used as the outer conductor and the outer conductor is constructed of only the metal foil.

Here, in the embodiment, the first shield layer 31 and the second shield layer 33 are preferably constructed of copper foil and are 30 μm or less in thickness. This is because even when strain is applied to the copper foil, the copper foil is within an elastic range of copper, and a tear etc. of the copper foil can be prevented and also, the thickness can be reduced to decrease the diameter of the coaxial cable 1.

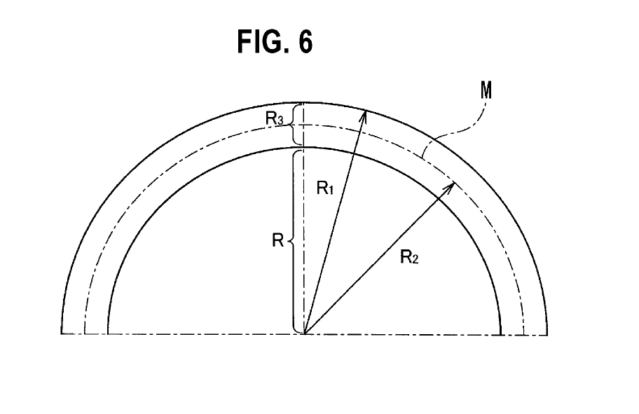

FIG. 6 is an explanatory diagram of strain of copper. As shown in FIG. 6, it is assumed that copper is bent in a predetermined bending radius. At this time, strain e applied to the copper can be expressed by e=ΔL/L. Here, ΔL is the amount (mm) of elongation of copper, and L is the length (mm) of the center of copper. In FIG. 6, the center of copper is shown by numeral M (chain line). When R1 is a bending radius of copper and R2 is a bending radius of the center of copper and R3 is a thickness of copper, it can be expressed by ΔL=2πR1−2πR2 and L=2πR2. Consequently, the strain e results in e=R1/R2−1. Since R1=R+R3 and R2=R+R3/2 are satisfied, e=(R+R3)/(R+R3/2)−1 is obtained.

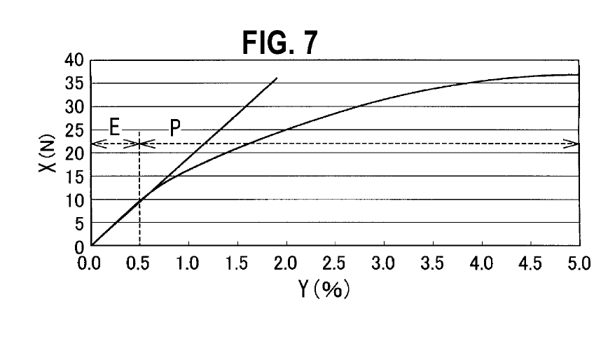

FIG. 7 is a graph showing elongation-strength characteristics of copper foil. In FIG. 7, numeral E shows an elastic range, and numeral P shows a plastic range. In FIG. 7, the axis of ordinate is strength X (N), and the axis of abscissa is elongation Y (%). In order to use the copper foil in the elastic range, it is necessary that the elongation of the copper foil should be 0.5% or less as shown in FIG. 7. As a result, when R shown in FIG. 6 is 3 mm required for the coaxial cable 1 from the above formulas, it is necessary that the thickness R3 of the copper foil should be 0.030 mm or less in order to set the strain e in 0.5% or less (the elastic range). Hence, by setting the thickness of the copper foil in 0.030 mm or less, the copper foil can be used in the elastic range and a tear etc. of the copper foil can be prevented and also, the thickness can be reduced to decrease the diameter of the coaxial cable 1.

The first shield layer 31 and the second shield layer 33 are preferably 8 μm or more in thickness. This is because a shielding effect in consideration of a skin effect on high-frequency waves is obtained.

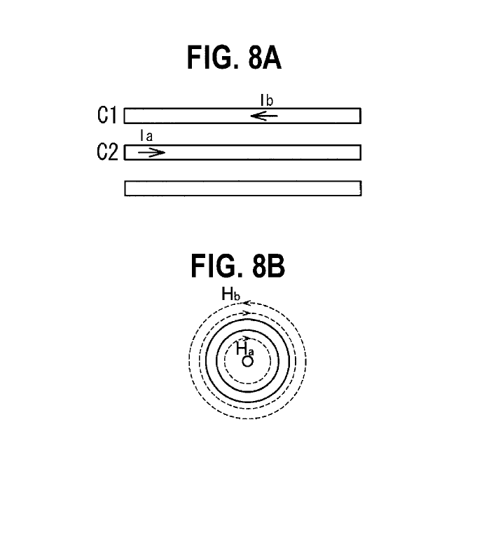

The details of the above reason will be described below. FIGS. 8A and 8B are first diagrams describing a shielding effect of a coaxial cable, and FIG. 8A shows a side schematic diagram, and FIG. 8B shows a sectional schematic diagram. In FIG. 8A, numeral C1 shows an outer conductor, and numeral C2 shows an inner conductor. In FIG. 8A, numeral Ia shows a current flowing through the inner conductor, and numeral Ib shows a return current flowing through an outer conductor layer. In FIG. 8B, numeral Ha shows a magnetic field produced by the current Ia, and numeral Hb shows a magnetic field produced by the return current Ib. As shown in FIG. 8A, in the coaxial cable, the current Ia flows through the inner conductor and also, the return current Ib flows through the outer conductor layer. Accordingly, as shown in FIG. 8B, the magnetic fields Ha, Hb produced by both of the currents Ia, Ib are generated in opposite directions and cancel out each other and thereby, a good shielding effect can be obtained.

Here, in a low frequency band of the current, as direct-current resistance of the outer conductor layer is lower, the shielding effect becomes better. This is because for the current with a low frequency, a wavelength of the current is long and the current is probably substantially a direct current.

On the other hand, a high frequency band of the current has the influence of a skin effect. That is, since a current tends to flow on a surface of the conductor as the frequency becomes high, the surface of the outer conductor layer is preferably smooth.

In a conventional product, the outer conductor layer is constructed of metal foil and braid covering its metal foil, and a current with a high frequency flows along unevenness of a surface of the braid. Consequently, by the amount flowing along the unevenness, resistance is increased to thereby decrease a magnetic field generated. Hence, there is a small cancel effect of the magnetic field Ha generated by the current Ia flowing through the inner conductor and the magnetic field Hb generated by the return current Ib flowing through the outer conductor layer.

On the other hand, in the coaxial cable 1 according to the embodiment, the first shield layer 31 and the second shield layer 33 are constructed of a metal layer such as metal foil with a smooth surface, with the result that as compared with the case of constructing the shield layer of braid, resistance is lower and also a magnetic field generated is higher. As a result, the coaxial cable 1 can increase the cancel effect of the magnetic fields.

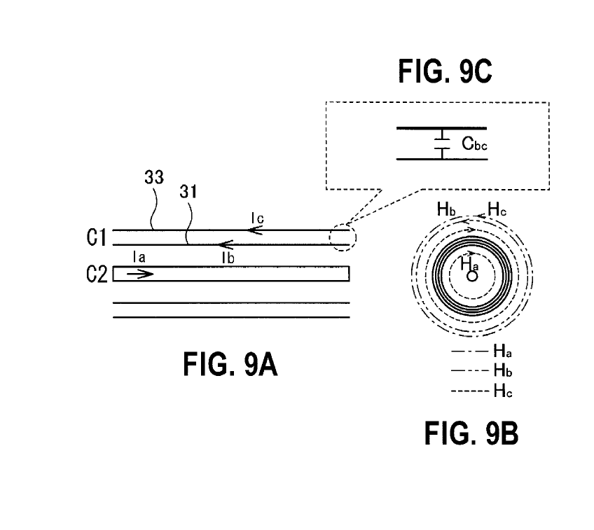

FIGS. 9A to 9C are second diagrams describing a shielding effect of a coaxial cable, and FIG. 9A shows a side schematic diagram, and FIG. 9B shows a sectional schematic diagram, and FIG. 9C shows an equivalent circuit of an outer conductor. In FIG. 9A, numeral C1 shows an outer conductor, and numeral C2 shows an inner conductor. In FIG. 9A, numeral Ia shows a current flowing through the inner conductor, and numerals Ib, Ic show return currents flowing through an outer conductor layer. In FIG. 9B, numeral Ha shows a magnetic field produced by the current Ia, and numerals Hb, Hc show magnetic fields respectively produced by the return currents Ib, Ic. Specifically, since the coaxial cable 1 according to the embodiment has the first shield layer 31 and the second shield layer 33, as shown in FIG. 9C, capacitive coupling between the first shield layer 31 and the second shield layer 33 is provided, and the return currents Ib, Ic flow through both of these shield layers. Then, the magnetic fields Hb, Hc are generated by the return currents Ib, Ic, and the magnetic fields Hb, Hc and the magnetic field Ha generated by the current Ia flowing through the inner conductor 10 cancel out.

Further, since the first shield layer 31 and the second shield layer 33 are 8 μm or more in thickness, the shield layers can be set in proper thickness even in consideration of a skin effect on frequencies from 76 to 108 MHz or more which are in, for example, an FM frequency band.

Concretely, when a thickness of a conductor through which high-frequency waves flow is δ, the thickness can be expressed by δ=(2/ωμσ)^{1/2}. Here, when ω=2πf and μ=4π×10⁻⁷ and σ is conductivity of copper and is 58×10⁵ (S/m), the thickness δ can be expressed by δ=2.09/(f(GHz))^{1/2}(μm).

From this formula, the thickness δ of the conductor through which the high-frequency waves flow becomes 0.008 mm for a frequency of 70 MHz in the vicinity of the lower limit of the FM frequency band. Hence, by setting the thickness in 8 μm or more, the thickness at the time when the high-frequency waves flow can be ensured in the first shield layer 31 and the second shield layer 33.

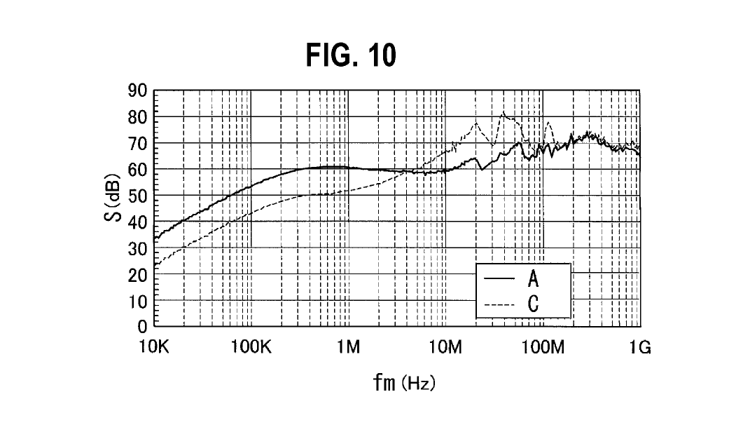

FIG. 10 is a graph showing shielding effects of the coaxial cable according to the embodiment and the conventional coaxial cable. In FIG. 10, numeral A (solid line) shows the conventional coaxial cable, and numeral C (dotted line) shows the coaxial cable 1 according to the embodiment. In FIG. 10, the axis of ordinate is a shielding effect S (dB), and the axis of abscissa is a measurement frequency fm (Hz). As shown in FIG. 10, by setting the thicknesses of the first shield layer 31 and the second shield layer 33 in 8 μm or more, the shielding effect is better in a domain of about 4 MHz or more though the shielding effect is worse in a domain of less than about 4 MHz than ever before.

Next, a manufacturing method of the coaxial cable 1 according to the embodiment will be described. In the case of manufacturing the coaxial cable 1 according to the embodiment, the outer peripheral side of the inner conductor 10 is first coated with the insulator 20 by an extruder.

Next, a film with the first shield layer 31 having the glue layer 50 on one surface, the insulating layer 32 and the second shield layer 33 integrated is stuck on the insulator 20. At this time, the film is stuck so that the side of the glue layer 50 faces the insulator 20. The film is once wound on an outer peripheral surface of the insulator 20.

Subsequently, the film (second shield layer 33) is coated with the sheath 40 by the extruder. At this time, heat by the extruder melts the glue layer 50 to make close contact between the insulator 20 and the first shield layer 31 with no gap.

Thus, according to the coaxial cable 1 according to the embodiment, the first shield layer 31 and the second shield layer 33 are made of the metal foil, with the result that manufacturing time can be reduced as compared with the case of braiding or spirally winding a metal wire. When the metal foil is used as the outer conductor, impedance characteristics may deviate from a prescribed value, but the first shield layer 31 is glued to the insulator 20, with the result that the impedance characteristics can be prevented from deviating from the prescribed value. Consequently, the coaxial cable capable of reducing the manufacturing time while forming the outer conductor in a two-layer structure can be provided.

Since the first shield layer 31 and the second shield layer 33 are 30 μm or less in thickness, the metal foil can be used in an elastic range with respect to a bending radius of 3 mm and also, the thickness of the whole coaxial cable 1 can be reduced to decrease the diameter of the coaxial cable 1.

Since the first shield layer 31 and the second shield layer 33 are 8 μm or more in thickness, a shielding effect in consideration of a skin effect on high-frequency waves can be obtained.

Since both of the first shield layer 31 and the second shield layer 33 are once wound, for example, as compared with the case of spirally winding the metal foil, a return current does not flow spirally and a resistance value of the outer conductor layer 30 can be prevented from being increased.

The invention has been described above based on the embodiment, but the invention is not limited to the embodiment described above, and changes may be made without departing from the gist of the invention.

For example, the coaxial cable 1 according to the embodiment is not limited to the coaxial cable described with reference to FIGS. 4 and 5, and various changes can be made. For example, it is unnecessary that the inner conductor 10 should be the annealed copper twisted wire or the sheath 40 should be the heat-resistant PVC. In the insulator 20 and the outer conductor layer 30, various changes can be made similarly.

Further, in the coaxial cable 1 according to the embodiment, the first shield layer 31 may differ from the second shield layer 33 in thickness, but the first shield layer 31 and the second shield layer 33 preferably have the same thickness. This is because when the thicknesses of these shield layers are set to obtain certain characteristics, one of both the shield layers 31, 33 does not become thick uselessly and the diameter of the coaxial cable 1 can be decreased.

The coaxial cable 1 according to the embodiment is summarized as described below.

(1) A coaxial cable 1 includes an inner conductor 10, an insulator 20 formed on an outer peripheral side of the inner conductor 10, an outer conductor layer 30 formed on an outer peripheral side of the insulator 20, and a sheath 40 formed on an outer peripheral side of the outer conductor layer 30. The outer conductor layer 30 has a first shield layer 31 made of metal foil, an insulating layer 32 formed on an outer peripheral side of the first shield layer 31, and a second shield layer 33 made of metal foil formed on an outer peripheral side of the insulating layer 32. The first shield layer 31 of the outer conductor layer 30 is glued to the insulator 20.

(2) Each of the first shield layer 31 and the second shield layer 33 is constructed of copper foil and is 30 μm or less in thickness.

(3) Each of the first shield layer 31 and the second shield layer 33 is 8 μm or more in thickness.

(4) In an aspect, the first shield layer 31 and the second shield layer 33 can have the same thickness.

(5) The first shield layer 31 is once wound on the insulator 20 and also, the second shield layer 33 is once wound on the insulating layer 32.

A coaxial cable according to the invention usefully can provide a coaxial cable capable of reducing manufacturing time while forming an outer conductor in a two-layer structure.

What is claimed is:

1. A coaxial cable comprising:
an inner conductor;
an insulator formed on an outer peripheral side of the inner conductor;
an outer conductor layer formed on an outer peripheral side of the insulator; and
a sheath formed on an outer peripheral side of the outer conductor layer,
wherein the outer conductor layer has:
a first shield layer made of metal foil;
an insulating layer formed on an outer peripheral side of the first shield layer; and
a second shield layer made of metal foil formed on an outer peripheral side of the insulating layer, and
the first shield layer of the outer conductor layer is glued to the insulator.

2. The coaxial cable according to claim 1, wherein each of the first shield layer and the second shield layer is constructed of copper foil and is 30 μm or less in thickness.

3. The coaxial cable according to claim 2, wherein each of the first shield layer and the second shield layer is 8 μm or more in thickness.

4. The coaxial cable according to claim 2, wherein the first shield layer and the second shield layer have the same thickness.

5. The coaxial cable according to claim 2, wherein the first shield layer is once wound on the insulator, and
the second shield layer is once wound on the insulating layer.
